(19) United States
(12) Patent Application Publication
(10) Pub. No.: US 2016/0012394 A1
(43) Pub. Date: Jan. 14, 2016

(54) ORDER FULFILLMENT SYSTEM

(71) Applicant: Karl Vance REED, Marksville, LA (US)

(72) Inventor: Karl Vance REED, Marksville, LA (US)

(21) Appl. No.: 14/858,362

(22) Filed: Sep. 18, 2015

Related U.S. Application Data
(63) Continuation of application No. 13/544,616, filed on Jul. 9, 2012, now abandoned.
(60) Provisional application No. 61/505,219, filed on Jul. 7, 2011.

(51) Int. Cl. G06Q 10/08; G06Q 30/06

(52) U.S. Cl. CPC G06Q 10/08355; G06Q 30/0635; G06Q 10/0875

(57) ABSTRACT

A process for fulfilling customers orders, the process comprising the steps of receiving an order including product information and customer information from a customer; providing a product according to the product information; creating a bill-of-material label including the customer information; coupling the bill-of-material label to the product; creating a delivery route using the customer information; and following the delivery route to deliver the product to the customer to fulfill the order.

### CROSS-REFERENCE TO RELATED APPLICATION

This application is a continuation of co-pending U.S. patent application Ser. No. 13/544,616, filed Jul. 9, 2012, which claims the benefit of U.S. Provisional Patent Application No. 61/505,219, filed Jul. 7, 2011, the disclosures of which are incorporated herein by reference in their entirety.

### FIELD

The present disclosure relates to a GPS based, bill-of-material verified, trackable, smart device enable method, device, and software system used in delivery or courier businesses.

The present disclosure integrates several modules of a software system, smart devices, and business methods to produce an efficient delivery or courier system that may decrease business costs, increase driver profit, or increase driver safety.

The software system may comprise various combinations of modules, wherein the modules may comprise an order processing module, a bill-of-material module, a GPS routing module, a payment module, a time tracking module, an employee cost module, a security module, a signature module, and a customer contact module. The software system may be a web-based application, a server based application, or an application run locally. For the purpose of this disclosure, each module may comprise an independent application, such as a smart device application, a block of code within a larger application, or a programming module that is referenced by an application. The modules of the software system may be run on a single machine or on a plurality of machines. The modules may be processed on one single machine or on a plurality of machines, wherein machines may comprise servers, computers, or smart devices. A smart device may comprise a portable computing unit such as a smart phone or tablet.

The system allows the business or business management to track its delivery or courier drivers using GPS (global positioning system) enabled devices in conjunction with software modules that can track a driver's position or driving characteristics. Other software modules may also rely on GPS information, such as a time tracking module that can change the task status of a driver from in store to out of store when the driver leaves the store with the device for delivery, or an employee cost tracking module that combines optional employee input with GPS information to calculate the employee's cost during deliveries. With an optional security module that records images or video, which are saved locally or uploaded wirelessly, the business can also monitor the driver for regulation, law, or employee handbook compliance. For example, GPS information can reveal the speed of the car, or video could show the speedometer of the car, which incentivizes a driver's adherence to speed limits. The camera input may comprise the camera integrated in a smart device or a stand-alone camera with internal or removable memory or with a wireless network or cloud connection. In an exemplary embodiment of the invention, the camera is head-mounted, such as on an ear piece, so that the camera input is similar to the driver's view. Increasing driver compliance may reduce business operational costs or prove business legal liability. The bill-of-material module verifies an order is complete before being removed from the store for delivery.

The system allows time and resource management by the driver, aids the driver in providing customer service, and may increase driver safety. The driver may utilize the bill-of-material module to confirm all parts of a delivery are ready before leaving the store. The GPS routing module receives the bill-of-material label information and optimizes a delivery route for a single or a plurality of delivery stops. In some embodiments of the invention, the GPS module can receive additional input from employees, customers, or community members regarding current traffic or neighborhood conditions. For example, a driver may input information regarding areas prone to crime so that the routing optimization can consider safer alternate routes. In one exemplary embodiment, the routing module provides only turn-by-turn directions to the delivery location to reduce the driver's ability to extract the customer's private information. In exemplary embodiments, the driver does not have direct access to a customer's mailing address or credit card information, which may reduce the customer's risk of identity theft.

The GPS routing module activates the optional customer contact module to send delivery updates to the customer as the driver is out for delivery. For example, the customer contact module may send an automatic notice when the driver is three minutes away from the delivery location with instructions to turn on the front light if it is after dark. The payment module can receive direct payments if the customer did not prepay to the order processing module. The signature capture module can receive a signature for the customer's prepaid credit card receipt or as confirmation of delivery. In one exemplary embodiment, the driver cannot view credit card information if the customer has prepaid.

After completion of the delivery, the customer contact module may send a follow-up notification automatically based on time lapsed or GPS-determined distance from the delivery location. Such follow-up notifications may comprise a thank you note customized by the tipping rate, incentives for future orders, or acknowledgement of a repeat customer. In certain exemplary embodiments of the invention, the driver manually activates the customer contact module or sends personalized notifications.

### BRIEF DESCRIPTION OF THE DRAWINGS

FIG. 1 shows a flow diagram of one exemplary embodiment comprising steps performed by various software modules that are executed by one or a plurality of machines.

FIG. 2 shows a flow diagram of one exemplary embodiment comprising steps performed by various software modules that are executed by one or a plurality of machines, wherein the software modules may comprise an order processing module, a bill-of-material module, or a GPS routing module.

FIG. 3 shows a flow diagram of one exemplary embodiment of a bill-of-material system comprising steps performed by various software modules that are executed by one or a plurality of machines, wherein the software modules may comprise an order processing module or a bill-of-material module.

FIG. 4 shows a flow diagram of one exemplary embodiment comprising steps performed by various software modules that are executed by one or a plurality of machines.

FIG. 5 shows a flow diagram of one exemplary embodiment comprising a plurality of machines running modules of the software system.

### DETAILED DESCRIPTION

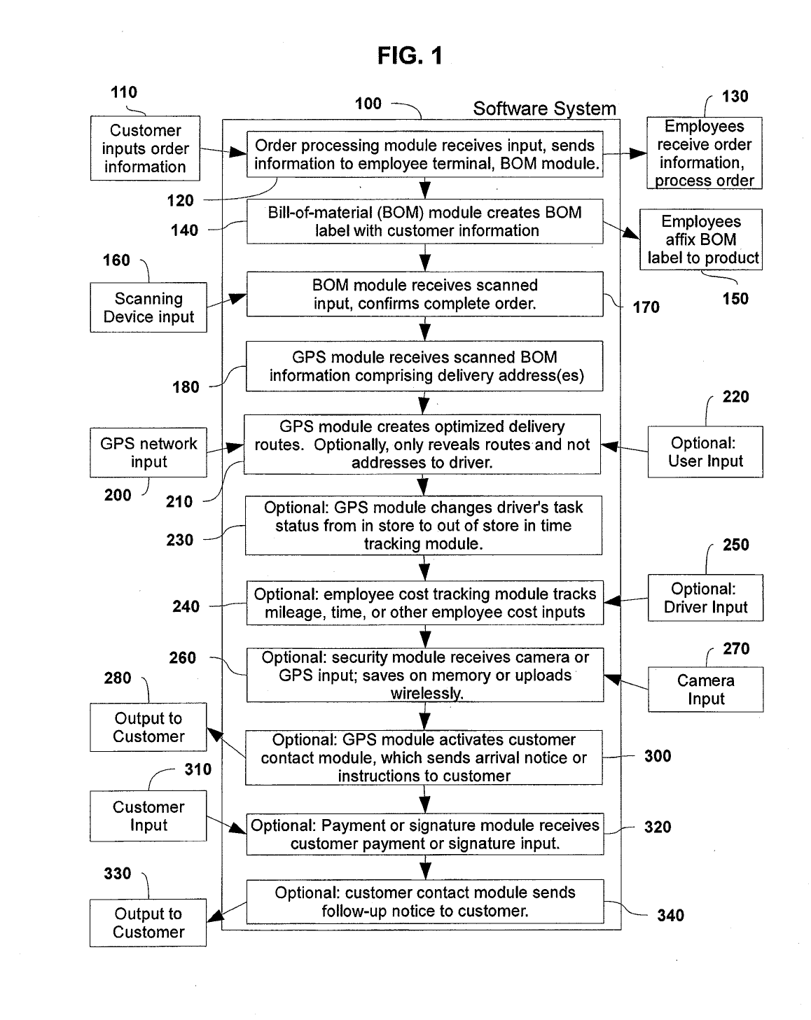

FIG. 1 shows one exemplary embodiment of a system comprising steps performed by various software modules that are executed by one or a plurality of machines. An order processing module 430 of a software system 100 running on a server 410 or computer receives customer input 110 or customer information from customer or employee (step 120). A customer can self-submit information via web or smart device application, or can contact employee via phone, web, or smart device application and the employee can input order information. Input 110 may also comprise communication preference, which may comprise text message, email, web application notification, or voice message. In certain embodiments, the order processing module 430 also displays an estimated delivery time for the customer, wherein the estimated time may be calculated by previous sales information, current sales volume, number of employees or drivers available, or type of delivery address (home, office, high-rise building, apartment, or the like).

Order processing module 430 of the software system 100 sends order information to the bill-of-material (BOM) module of the software system 100, and optionally sends order information to an employee terminal or to another computer or device running the software system 100 (step 120). Employees fulfill the customer order (step 130). In certain embodiments, part or all of the order may be completed by an automated process, such as by an automated assembly line.

In step 140, bill-of-material module 440 running on software system 100 generates bill-of-material label to be attached to order. Bill-of-material label may comprise a barcode, a contents list, an RFID tag, or other trackable code. Bill-of-material label may refer to customer information on the software system 100, which may comprise all components of the order, customer's address, or customer's contact information. Employees or an automated process attach the bill-of-material label to the order (step 150). Depending on the order, there may be multiple parts of a complete order, in which case there would be a label for each part of the order.

The bill-of-material module 440 on software system 100 receives input from a scanning device 160, wherein the input 160 is comprised of the bill-of-material label on an order that has been prepared for delivery and the scanning device comprises the driver's system enabled smart device 520 (step 170). In another exemplary embodiment, the software system 100 receives input from a scanning device 160, wherein a scanning device may comprise a hand-held or stationary code reader that is separate from the system enabled smart device 520. Delivery driver may carry more than one order per trip. Devices may be considered system enabled if they are running a version of the software system 100, a mobile version of the software system 100, or a smart device application with integration to the software system 100.

The GPS routing module 450 of the software system 100 receives customer information from bill-of-material module 440, wherein customer information comprises customer delivery location (step 180). System enabled smart device 520 uses GPS routing module 450 to produce optimized delivery route or routes for driver (step 210). GPS routing module 450 may receive GPS network input 200, or may use locally accessible maps if the network is unavailable. Route or routes may change or update during the duration of the delivery trip to accommodate changes in traffic conditions, or the like. In certain embodiments, the GPS routing module 450 can receive additional user input 220 from employees, customers, or community members regarding current traffic or neighborhood conditions. For example, a driver may input information regarding areas prone to crime so that the routing optimization can consider safer alternate routes.

Upon being removed from the location of origin, e.g., the store, the time tracking module 460 of the software system 100 on the enabled device updates the driver's task status from in store to on delivery based on the change in the GPS location (step 230). The time tracking module 460 may also transmit this information to the software system 100 running on a server 410 or computer for access by management or accounting personnel. Optionally, an employee cost module 470 may be also be activated by the change in GPS location (step 240). This module could receive driver inputs 250 such as gas cost, miles per gallon of gas consumed by the driver's vehicle, vehicle insurance costs, or the like, to track the driver's expenditures while on delivery.

Driver mounts enabled smart device 520 in vehicle during delivery. The security module 480 of software system 100 running on smart device 520 may record video, images, GPS information, or other information about driving experience to provide feedback to service provider (step 260). Images or video maybe be received by the security module 480 from a camera input 270, wherein camera input may comprise the camera integrated in a smart device or a stand-alone camera with internal or removable memory or with a wireless network or cloud connection. In an exemplary embodiment of the invention, the camera is head-mounted, such as on an ear piece, so that the camera input is similar to the driver's view. Feedback may comprise adherence to local traffic laws, compliance with company safety requirements, or information about a suspect in case of criminal cases where the driver is a victim. Feedback may be stored on locally accessible memory or may be transmitted wirelessly to another storage medium.

At a pre-defined point before the delivery driver's arrival at a customer's location, the GPS routing module 450 activates the customer service module of the software system 100 to send a notification 280 to the customer of arrival time (step 300). If the customer has selected a method of notification that allows for picture or video retrieval, the notification 280 sent by the customer contact module 490 may comprise a picture or video of the driver or the driver's vehicle in the notification. For example, a customer may receive a picture text message of the driver and the driver's vehicle with a notification that the driver will arrive in three minutes. In another exemplary embodiment, the customer contact module 490 sends a picture or video of the driver or the driver's vehicle to the customer with confirmation of placing the order successfully, or with notification that the delivery had left the provider's location, or at another time before the arrival of the delivery driver at the customer's location. In certain embodiments, the automated phone call or text message is sent from the driver's number. In other exemplary embodiments, the automated phone call or text message is sent from the store's number or another official number.

When the delivery driver arrives at the customer location and the delivery driver provides the order to the customer, the payment module 500 or signature capture module 510 of the software system 100 running on the system enabled smart device 520 receives input 310 from the delivery driver or the customer to verify the order or payment to conclude the transaction (step 320).

Optionally, the customer contact module 490 of the software system 100 may send a follow-up notification 330 to the customer after the conclusion of the delivery via the customer's notification method or by another notification method provided by the customer (step 340). The follow-up notification may be manually or automatically generated and manually or automatically sent by the delivery driver or the service provider. The follow-up notification may comprise verification of the completed order, a thank you message for the order or the tip paid to the driver, or promotional incentive for future orders.

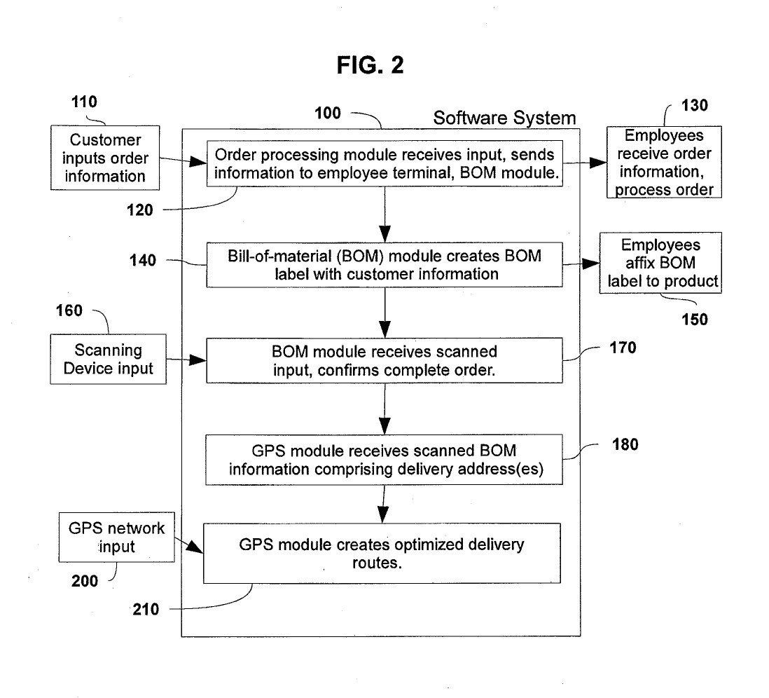

FIG. 2 shows one exemplary embodiment of a system comprising steps performed by various software modules that are executed by one or a plurality of machines, wherein the software modules may comprise an order processing module, a bill-of-material module, or a GPS routing module. An order processing module 430 of a software system 100 running on a server 410 or computer receives customer input 110 or customer information from customer or employee (step 120). Customer can self-submit information via web or smart device application, or can contact employee via phone, web, or smart device application and the employee can input order information. Input 110 may also comprise communication preference, which may comprise text message, email, web application notification, or voice message. In certain embodiments, the order processing module 430 also displays an estimated delivery time for the customer, wherein the estimated time may be calculated by previous sales information, current sales volume, number of employees or drivers available, or type of delivery address (home, office, high-rise building, apartment, or the like).

Order processing module 430 of the software system 100 sends order information to the bill-of-material (BOM) module of the software system 100, and optionally sends order information to an employee terminal or to another computer or device running the software system 100 (step 120). Employees fulfill the customer order (step 130). In certain embodiments, part or all of the order may be completed by an automated process, such as by an automated assembly line.

In step 140, bill-of-material module 440 running on software system 100 generates bill-of-material label to be attached to order. Bill-of-material label may comprise a barcode, a contents list, an RFID tag, or other trackable code. Bill-of-material label may refer to customer information on the software system 100, which may comprise all components of the order, customer's address, or customer's contact information. Employees or an automated process attach the bill-of-material label to the order (step 150). Depending on the order, there may be multiple parts of a complete order, in which case there would be a label for each part of the order.

The bill-of-material module 440 on software system 100 receives input from a scanning device 160, wherein the input 160 is comprised of the bill-of-material label on an order that has been prepared for delivery and the scanning device comprises the driver's system enabled smart device 520 (step 170). In one exemplary embodiment, the software system 100 receives input from a scanning device 160, wherein a scanning device may comprise a hand-held or stationary code reader that is separate from the system enabled smart device 520. Delivery driver may carry more than one order per trip. Devices may be considered system enabled if they are running a version of the software system 100, a mobile version of the software system 100, or a smart device application with integration to the software system 100.

The GPS routing module 450 of the software system 100 receives customer information from bill-of-material module 440, wherein customer information comprises customer delivery location (step 180). System enabled smart device 520 uses GPS routing module 450 to produce optimized delivery route or routes for driver (step 210). GPS routing module 450 may receive GPS network input 200, or may use locally accessible maps if the network is unavailable. Route or routes may change or update during the duration of the delivery trip to accommodate changes in traffic conditions, etc.

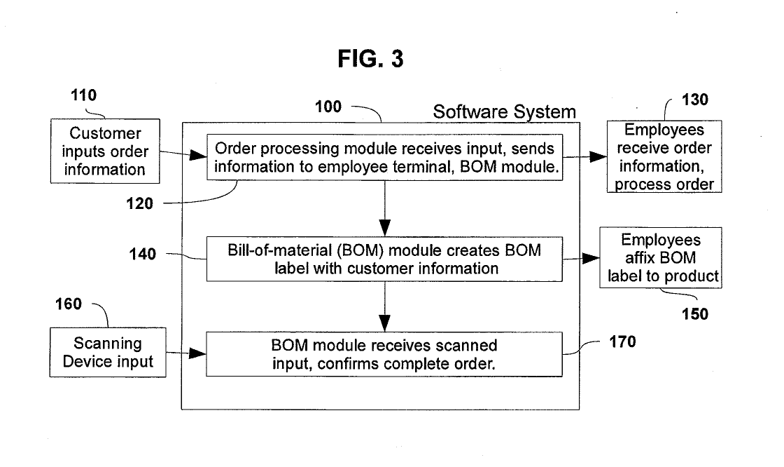

FIG. 3 shows an exemplary bill-of-material embodiment comprising steps performed by various software modules that are executed by one or a plurality of machines, wherein the software modules may comprise an order processing module or a bill-of-material module. An order processing module 430 of a software system 100 running on a server 410 or computer receives customer input 110 or customer information from customer or employee (step 120). A customer can self-submit information via web or smart device application, or can contact employee via phone, web, or smart device application and the employee can input order information. Input 110 may also comprise communication preference, which may comprise text message, email, web application notification, or voice message.

Order processing module 430 of the software system 100 sends order information to the bill-of-material (BOM) module of the software system 100, and optionally sends order information to an employee terminal or to another computer or device running the software system 100 (step 120). Employees fulfill the customer order (step 130). In certain embodiments, part or all of the order may be completed by an automated process, such as by an automated assembly line.

In step 140, bill-of-material module 440 running on software system 100 generates bill-of-material label to be attached to order. Bill-of-material label may comprise a barcode, a contents list, an RFID tag, or other trackable code. Bill-of-material label may refer to customer information on the software system 100, which may comprise all components of the order, customer's address, or customer's contact information. Employees or an automated process attach the bill-of-material label to the order (step 150). Depending on the order, there may be multiple parts of a complete order, in which case there would be a label for each part of the order.

The bill-of-material module 440 on software system 100 receives input from a scanning device 160, wherein the input 160 is comprised of the bill-of-material label on an order that has been prepared and the scanning device comprises system enabled smart device 520 (step 170). In another exemplary embodiment, the software system 100 receives input from a scanning device 160, wherein a scanning device may comprise a hand-held or stationary code reader that is separate from the system enabled smart device 520. Devices may be considered system enabled if they are running a version of the software system 100, a mobile version of the software system 100, or a smart device application with integration to the software system 100.

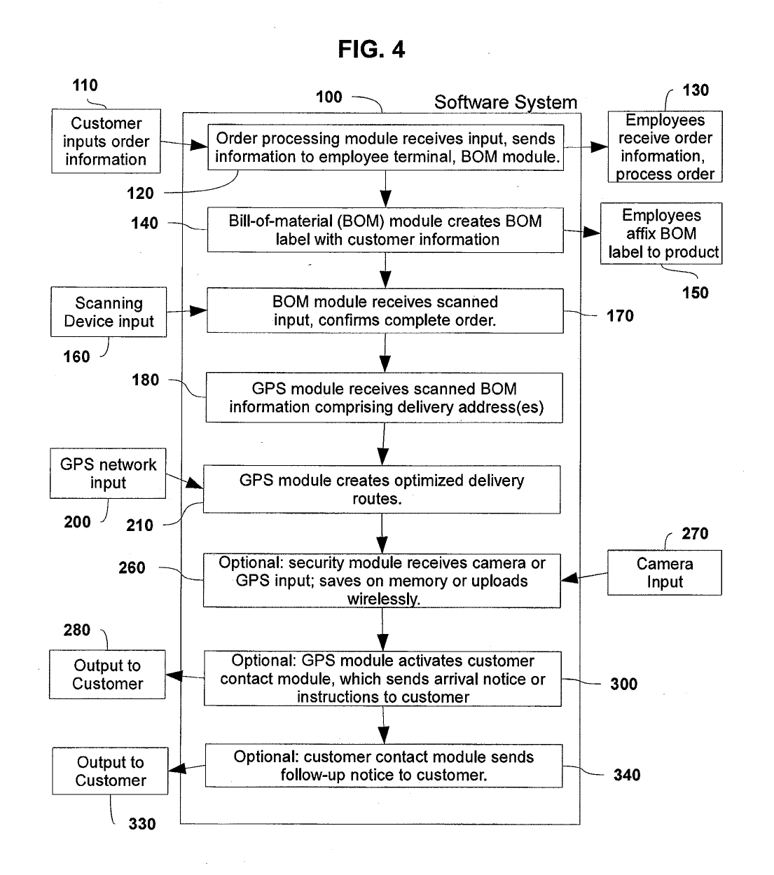

FIG. 4 shows another embodiment of the invention comprising steps performed by various software modules that are executed by one or a plurality of machines. An order processing module 430 of a software system 100 running on a server 410 computer receives customer input 110 or customer information from customer or employee (step 120). Customer can self-submit information via web or smart device application, or can contact employee via phone, web, or smart device application and the employee can input order information. Input 110 may also comprise communication preference, which may comprise text message, email, web application notification, or voice message. In some embodiments of the invention, the order processing module 430 also displays an estimated delivery time for the customer, wherein the estimated time may be calculated by previous sales information, current sales volume, number of employees or drivers available, or type of delivery address (home, office, high-rise building, apartment, or the like).

Order processing module 430 of the software system 100 sends order information to the bill-of-material (BOM) module of the software system 100, and optionally sends order information to an employee terminal or to another computer or device running the software system 100 (step 120). Employees fulfill the customer order (step 130). In certain exemplary embodiments, part or all of the order may be completed by an automated process, such as by an automated assembly line.

In step 140, bill-of-material module 440 running on software system 100 generates bill-of-material label to be attached to order. Bill-of-material label may comprise a barcode, a contents list, an RFID tag, or other trackable code. Bill-of-material label may refer to customer information on the software system 100, which may comprise all components of the order, customer's address, or customer's contact information. Employees or an automated process attach the bill-of-material label to the order (step 150). Depending on the order, there may be multiple parts of a complete order, in which case there would be a label for each part of the order.

The bill-of-material module 440 on software system 100 receives input from a scanning device 160, wherein the input 160 is comprised of the bill-of-material label on an order that has been prepared for delivery and the scanning device comprises the driver's system enabled smart device 520 (step 170). In another exemplary embodiment, the software system 100 receives input from a scanning device 160, wherein a scanning device may comprise a hand-held or stationary code reader that is separate from the system enabled smart device 520. Delivery driver may carry more than one order per trip. Devices may be considered system enabled if they are running a version of the software system 100, a mobile version of the software system 100, or a smart device application with integration to the software system 100.

The GPS routing module 450 of the software system 100 receives customer information from bill-of-material module 440, wherein customer information comprises customer delivery location (step 180). System enabled smart device 520 uses GPS routing module 450 to produce optimized delivery route or routes for driver (step 210). GPS routing module 450 may receive GPS network input 200, or may use locally accessible maps if the network is unavailable. Route or routes may change or update during the duration of the delivery trip to accommodate changes in traffic conditions, or the like.

Driver mounts enabled smart device 520 in vehicle during delivery. The security module 480 of software system 100 running on smart device 520 may record video, images, GPS information, or other information about driving experience to provide feedback to service provider (step 260). Images or video maybe be received by the security module 480 from a camera input 270, wherein camera input may comprise the camera integrated in a smart device or a stand-alone camera with internal or removable memory, with a wireless network, a remote server or a cloud storage connection. In one exemplary embodiment, the camera is head-mounted, such as on an ear piece, so that the camera input is similar to the driver's view. Feedback may comprise adherence to local traffic laws, compliance with company safety requirements, or information about a suspect in case of criminal cases where the driver is a victim. Feedback may be stored on locally accessible memory or may be transmitted wirelessly to another storage medium.

At a pre-defined point before the delivery driver's arrival at a customer's location, the GPS routing module 450 activates the customer service module of the software system 100 to send a notification 280 to the customer of arrival time (step 300). If the customer has selected a method of notification that allows for picture or video retrieval, the notification 280 sent by the customer contact module 490 may comprise a picture or video of the driver or the driver's vehicle in the notification. For example, a customer may receive a picture text message of the driver and the driver's vehicle with a notification that the driver will arrive in three minutes. In another exemplary embodiment, the customer contact module 490 sends a picture or video of the driver or the driver's vehicle to the customer with confirmation of placing the order successfully, or with notification that the delivery had left the provider's location, or at another time before the arrival of the delivery driver at the customer's location. In some embodiments of the invention, the automated phone call or text message is sent from the driver's number. In other embodiments of the invention, the automated phone call or text message is sent from the store's number or another official number.

Optionally, the customer contact module 490 of the software system 100 may send a follow-up notification 330 to the customer after the conclusion of the delivery via the customer's notification method or by another notification method provided by the customer (step 340). The follow-up notification may be manually or automatically generated and manually or automatically sent by the delivery driver or the service provider. The follow-up notification may comprise verification of the completed order, a thank you message for the order or the tip paid to the driver, or promotional incentive for future orders.

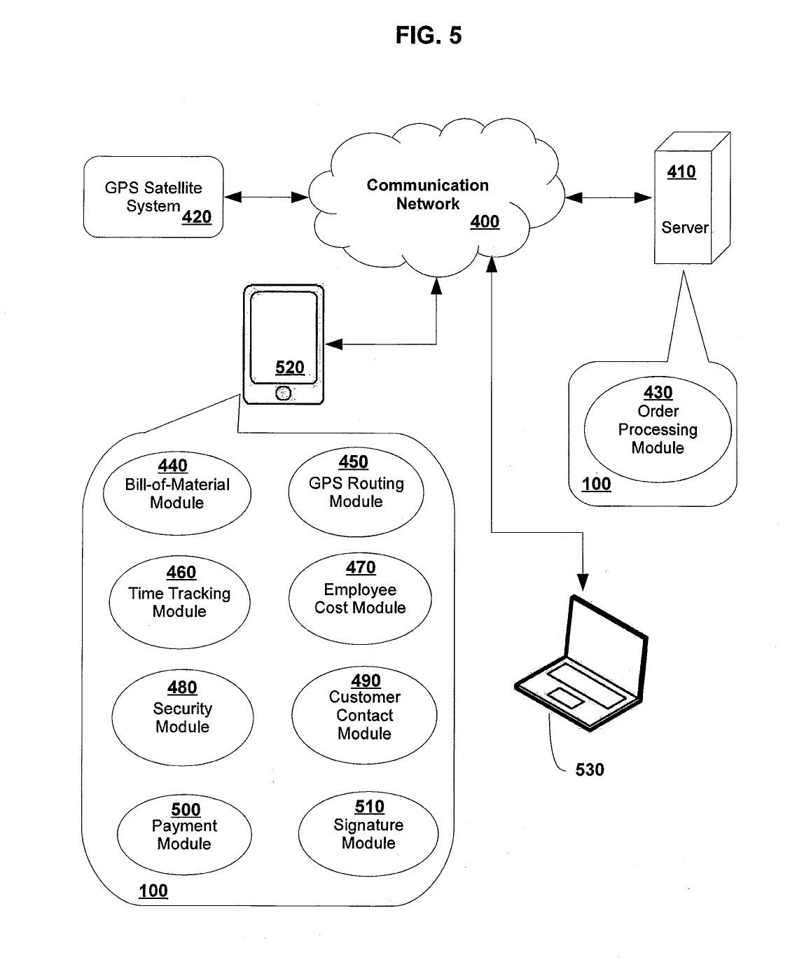

FIG. 5 shows one exemplary embodiment comprising a plurality of machines running modules of the software system. In the depicted embodiment, server 410 running software system 100 and smart device 520 running software system 100 are connected to a communication network 400. A GPS satellite system 420 and a customer device 530 are also connected to said communication network 400. A communication network 400 may comprise a local area network, interne service, cellular network, or another connectivity source. A smart device 520 may comprise a portable computing unit such as a smart phone or tablet. In accordance with other embodiments of the invention, other machines running a software system 100, such as a personal computer or a point-of-sale terminal, may be connected to the communication network 400. A customer device 530 may comprise a smart device, telephone, cellular phone, personal computer, or another device capable of accessing the communication network 400. In some embodiments of the invention, only one machine runs the software system. In the embodiment depicted in FIG. 5, the modules of the software system 100 running on smart device 520 comprise the following modules: bill-of-material module 440, GPS routing module 450, time tracking module 460, employee cost module 470, security module 480, customer contact module 490, payment module 500, or signature module 510. Software system 100 on a server 410 comprises an order processing module 430.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Claimed is:

1. A process for fulfilling customers orders, the process comprising the steps of
a. receiving an order including product information and customer information from a customer;
b. providing a product according to the product information;
c. creating a bill-of-material label including the customer information;
d. coupling the bill-of-material label to the product;
e. creating a delivery route using the customer information; and
f. following the delivery route to deliver the product to the customer to fulfill the order.

2. The process of claim 1, further comprising the step of verifying the product has been delivered by receiving an input.

3. The process of claim 1, further comprising the step sending a communication to the customer after the following the delivery route step.

4. The process of claim 3, wherein the communication is an arrival notice.

5. The process of claim 3, wherein the communication includes instructions to be performed by the customer.

6. The process of claim 3, wherein the communication is a follow-up notice.

7. The process of claim 1, further comprising the step of receiving delivery information from the customer after the following the delivery route step, wherein the delivery information includes one of customer payment information and customer signature information.

8. The process of claim 1, further comprising the step of changing a driver's task status from being in the store to being out of the store during the following the delivery route step.
